(19) United States
(12) Patent Application Publication
(10) Pub. No.: US 2008/0130112 A1
(43) Pub. Date: Jun. 5, 2008

(54) OPTICAL PLATE HAVING THREE LAYERS

(75) Inventors: TUNG-MING HSU, Tu-Cheng (TW); SHAO-HAN CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/620,951

(22) Filed: Jan. 8, 2007

(30) Foreign Application Priority Data
Dec. 1, 2006 (CN) 200610201193.2

(51) Int. Cl. G02B 5/02

(52) U.S. Cl. 359/599; 359/831

(57) ABSTRACT

An optical plate includes a first transparent layer, a second transparent layer and a light diffusion layer between the first and second transparent layers. The first transparent layer, the light diffusion layer, and the second transparent layer are integrally formed, with the first transparent layer in immediate contact with the light diffusion layer, and the second transparent layer in immediate contact with the light diffusion layer. The first transparent layer defines a plurality of V-shaped protrusions protruding out from an outer surface distalmost from the first transparent layer. The second transparent layer defines a plurality of conical frustum depressions at an outer surface thereof distalmost from the first transparent layer.

### BACKGROUND OF THE INVENTION

1. Field of the Invention

The present invention generally relates to optical plates, and more particularly, to an optical plate for use in, for example, a liquid crystal display (LCD).

2. Discussion of the Related Art

The lightness and slimness of LCD panels make them suitable for a wide variety of uses in electronic devices such as personal digital assistants (PDAs), mobile phones, portable personal computers, and other electronic appliances. Liquid crystal is a substance that cannot by itself emit light. Instead, the liquid crystal relies on receiving light from a light source in order to display images and data. In the case of a typical LCD panel, a backlight module powered by electricity supplies the needed light.

FIG. 7 is an exploded, side cross-sectional view of a typical backlight module 10 employing a typical optical diffusion plate. The backlight module 10 includes a housing 11, a plurality of lamps 12 disposed on a base of the housing 11, and a light diffusion plate 13 and a prism sheet 14 stacked on the housing 11 in that order. The lamps 12 emit light rays, and inside walls of the housing 11 are configured for reflecting some of the light rays upwards. The light diffusion plate 13 includes a plurality of dispersion particles. The dispersion particles are configured for scattering received light rays and thereby enhancing the uniformity of light rays that exit the light diffusion plate 13. The prism sheet 14 includes a plurality of V-shaped structures on a top thereof. The V-shaped structures are configured for collimating received light rays to a certain extent.

In use, the light rays from the lamps 12 enter the prism sheet 14 after being scattered in the diffusion plate 13. The light rays are refracted by the V-shaped structures of the prism sheet 14 and are thereby concentrated so as to increase brightness of light illumination. Finally, the light rays propagate into an LCD panel (not shown) disposed above the prism sheet 14. Even though the diffusion plate 13 and the prism sheet 14 are in contact with each other, a plurality of air pockets still existing at the boundary therebetween. When the backlight module 10 is in use, light passes through the air pockets, and some of the light undergoes total reflection at one or another of the corresponding boundaries. As a result, the light energy utilization ratio of the backlight module 10 is reduced.

Therefore, a new optical plate is desired in order to overcome the above-described shortcomings.

### SUMMARY

An optical plate includes a first transparent layer, a second transparent layer and a light diffusion layer between the first and second transparent layers. The light diffusion layer includes a transparent matrix resin and a plurality of diffusion particles dispersed in the transparent matrix resin. The first transparent layer, the light diffusion layer, and the second transparent layer are integrally formed, with the first transparent layer in immediate contact with the light diffusion layer, and the second transparent layer in immediate contact with the light diffusion layer. The first transparent layer defines a plurality of V-shaped protrusions protruding out from an outer surface distalmost from the first transparent layer. The second transparent layer defines a plurality of conical frustum depressions at an outer surface thereof distalmost from the first transparent layer.

Other novel features will become more apparent from the following detailed description, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present optical plate. Moreover, in the drawings, like reference numerals designate corresponding parts throughout the several views, and all the views are schematic.

FIG. 1 is an isometric view of an optical plate in accordance with a first embodiment of the present invention.

FIG. 2 is a cross-sectional view of the optical plate of FIG. 1, taken along line II-II thereof.

FIG. 3 is a bottom plan view of the optical plate of FIG. 1.

FIG. 4 is a top plan view of the optical plate of FIG. 1.

FIG. 5 is a top plan view of an optical plate in accordance with a second embodiment of the present invention.

FIG. 6 is a top plan view of an optical plate in accordance with a third embodiment of the present invention.

FIG. 7 is an exploded, side cross-sectional view of a conventional backlight module.

### DETAILED DESCRIPTION OF THE EMBODIMENTS

Reference will now be made to the drawings to describe preferred embodiments of the present optical plate, in detail.

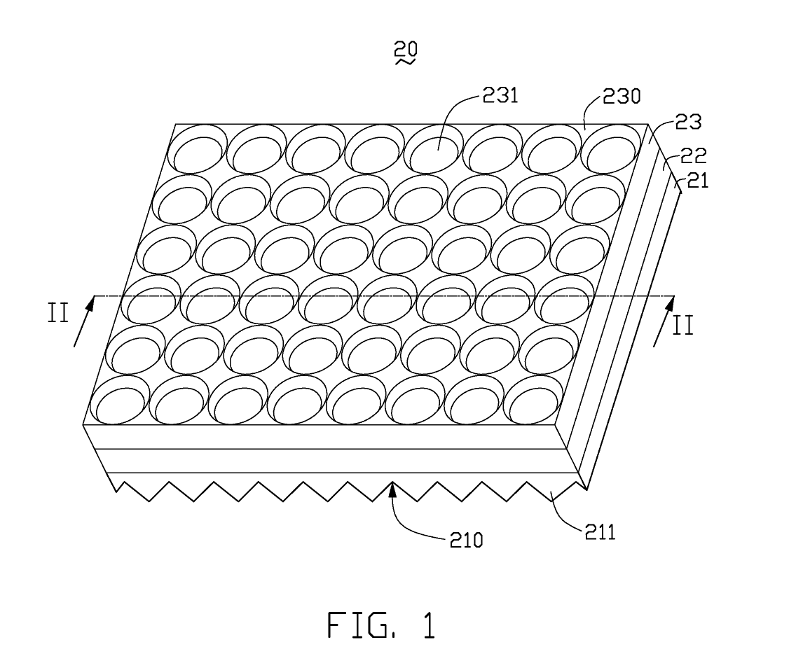

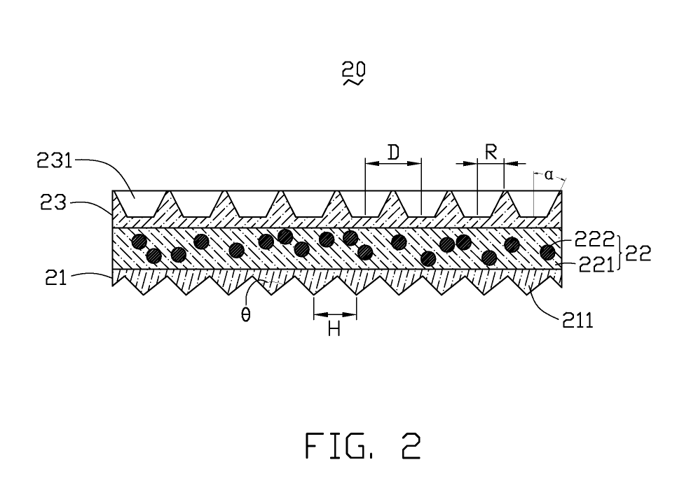

Referring to FIGS. 1 and 2, an optical plate 20 according to a first embodiment is shown. The optical plate 20 includes a first transparent layer 21, a light diffusion layer 22, and a second transparent layer 23. The first transparent layer 21, the light diffusion layer 22 and the second transparent layer 23 are integrally formed, with the light diffusion layer 22 being between the first and second transparent layers 21, 23. The first transparent layer 21 and the light diffusion layer 22 are in immediate contact with each other at a common interface thereof. Similarly, the second transparent layer 23 and the light diffusion layer 22 are in immediate contact with each other at a common interface thereof. This kind of unified body with no gaps in the common interfaces can be made by a multi-shot injection mold. The first transparent layer 21 defines a plurality of V-shaped protrusions 211 protruding out from an outer surface 210 thereof distalmost from the light diffusion layer 22. The second transparent layer 23 defines a plurality of conical frustum depressions 231 at an outer surface 230 thereof distalmost from the light diffusion layer 22.

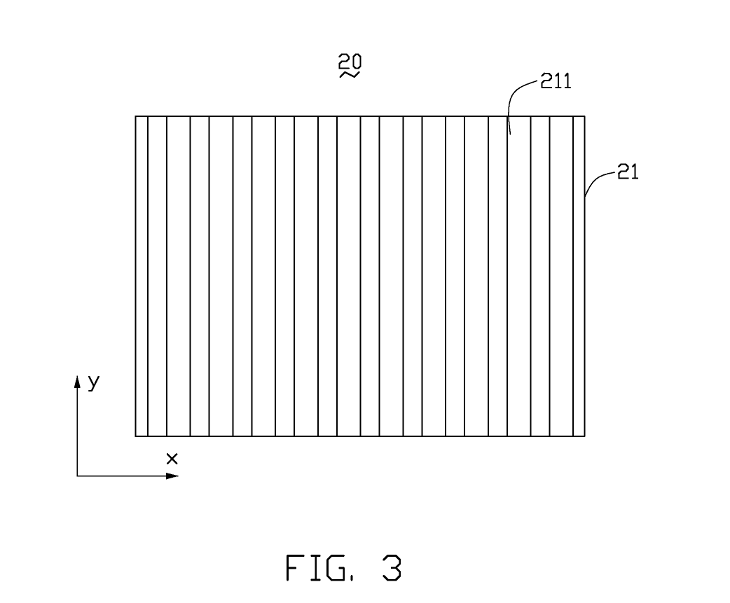

Referring to FIGS. 1 and 3, in the illustrated embodiment, each of the V-shaped protrusions 211 is an elongated ridge extending along a direction parallel to a side surface of the optical plate 20. The V-shaped protrusions 211 are aligned side by side on an outer surface 210 of the first transparent layer 21, and are parallel to each other. A pitch H between two adjacent V-shaped protrusions 211 is in a range from about 0.025 millimeters to 1 millimeter. A vertex angle θ of each V-shaped protrusion 211 is in a range from about 60 degrees to about 120 degrees. It is to be understood that the V-shaped protrusions 211 can be configured otherwise. For example, each of the V-shaped protrusions 211 can instead be a right-angled triangle prism, with one face of the prism parallel to the side surface of the optical plate 20, and another face of the prism generally facing toward but slanted relative to an opposite side surface of the optical plate 20.

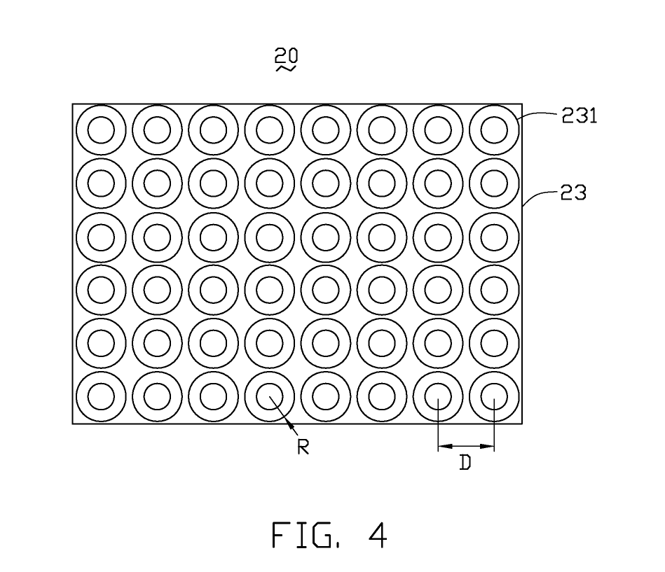

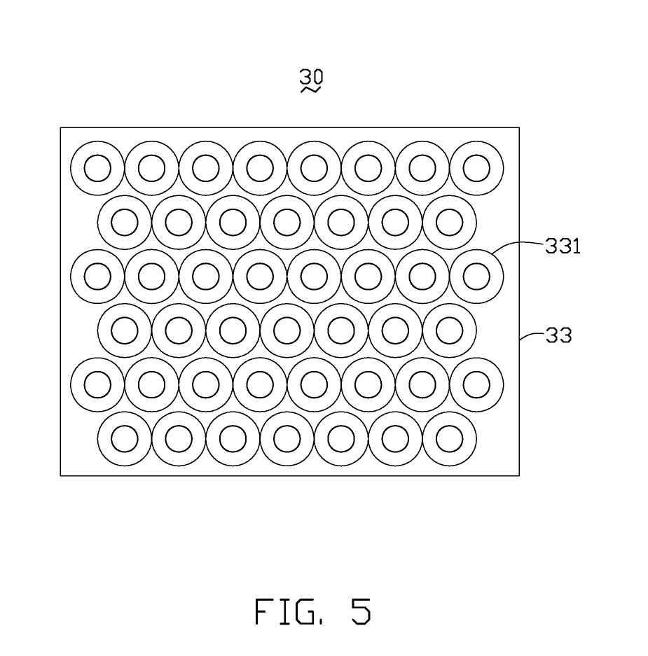

Referring to FIG. 4, the conical frustum depressions 231 are formed at the outer surface 230 of the second transparent layer 23 in a regular m×n matrix arrangement. Also referring to FIGS. 1 and 2, each conical frustum depression 231 is flared, and defines a central (vertical) axis of symmetry. A horizontal width of the conical frustum depression 231 decreases from a top end of the conical frustum depression 231 to a bottom end of the conical frustum depression 231. Thus a cross-section taken along the axis of symmetry of the conical frustum depression 231 defines an isosceles trapezium. A thickness of each of the first transparent layer 21, the light diffusion layer 22, and the second transparent layer 23 may be greater than or equal to 0.35 millimeters. In a preferred embodiment, a combined thickness of the first transparent layer 21, the light diffusion layer 22 and the second transparent layer 23 may be in the range from about 1.05 millimeters to about 6 millimeters. Each of the first transparent layer 21 and the second transparent layer 23 is made of transparent matrix resin selected from the group consisting of polyacrylic acid (PAA), polycarbonate (PC), polystyrene (PS), polymethyl methacrylate (PMMA), methylmethacrylate and styrene (MS), and any combination thereof. It should be noted that the material the first and second transparent layers 21, 23 may be the same or may be different.

In consideration of light diffusing effects, a pitch D between two adjacent conical frustum depressions 231 is configured to be preferably in the range from about 0.025 millimeters to about 1.5 millimeters. A maximal radius R of a top end of each conical frustum depression 231 is configured to be in the range D/4≦R≦D/2. Accordingly, the radius R is preferably in the range from about 6.25 microns to about 0.75 millimeters. An angle of an inner side surface of the depression 231 with respect to a central axis of the depression 231 is preferably in the range from about 30 degrees to about 75 degrees.

The light diffusion layer 22 includes a transparent matrix resin 221, and a plurality of diffusion particles 222 dispersed in the transparent matrix resin 221. The transparent matrix resin 221 is selected from the group consisting of polyacrylic acid (PAA), polycarbonate (PC), polystyrene (PS), polymethyl methacrylate (PMMA), methylmethacrylate and styrene (MS), and any combination thereof. The diffusion particles 222 can be made of material selected from the group consisting of titanium dioxide, silicon dioxide, acrylic resin, and any combination thereof. The diffusion particles 222 are configured for scattering light rays and enhancing the uniformity of light exiting the light diffusion layer 22. The light diffusion layer 22 preferably has a light transmission ratio in the range from 30% to 98%. The light transmission ratio of the light diffusion layer 22 is determined by a composition of the transparent matrix resin 221 and the diffusion particles 222.

In this embodiment, an interface between the light diffusion layer 22 and the first transparent layer 21 is flat. Similarly, an interface between the light diffusion layer 22 and the second transparent layer 23 is flat. Alternatively, the interface between the light diffusion layer 22 and the first transparent layer 21 may be non-planar. Similarly, the interface between the light diffusion layer 22 and the second transparent layer 23 may be non-planar. Examples of such non-planar interfaces include curved interfaces such as wavy interfaces. In these kinds of alternative embodiments, a binding strength between the light diffusion layer 22 and the first transparent layer 21 can be increased. Similarly, a binding strength between the light diffusion layer 22 and the second transparent layer 23 can be increased.

It should be noted that when the optical plate 20 is used in a direct type backlight module, either the first transparent layer 21 or the second transparent layer 23 of the optical plate 20 can be arranged to face a light source of the backlight module. Light rays from the light source directly enter the optical plate 20 via the first transparent layer 21 or the second transparent layer 23.

When the light rays enter the optical plate 20 via the first transparent layer 21, the light rays are diffused by the V-shaped protrusions 211 of the first transparent layer 21. Then the light rays are substantially further diffused in the light diffusion layer 22 of the optical plate 20. Finally, many or most of the light rays are condensed by the conical frustum depressions 231 of the second transparent layer 23 before they exit the optical plate 20. As a result, a brightness of the backlight module can be increased. In addition, the light rays are diffused twice, so that an optical uniformity of the optical plate 20 is enhanced. Moreover, the first transparent layer 21, the light diffusion layer 22, and the second transparent layer 23 are integrally formed together (see above), with no air or gas pockets trapped in the respective interfaces therebetween. Thus the efficiency of utilization of light rays is increased. Furthermore, when the optical plate 20 is assembled into a backlight module, the optical plate 20 in effect replaces the conventional combination of a diffusion plate and a prism sheet. Therefore compared with conventional art, a process of assembly of the backlight module is simplified and the efficiency of assembly is improved. Moreover, in general, a space occupied by the optical plate 20 is less than that occupied collectively by the conventional combination of a diffusion plate and a prism sheet. Thus a size of the backlight module can also be reduced.

When the light rays enter the optical plate 20 via the second transparent layer 23, the optical uniformity of the optical plate 20 is also enhanced, and the utilization efficiency of light rays is also increased. Nevertheless, the light rays emitted from the optical plate 20 via the first transparent layer 21 are different from the light rays emitted from the optical plate 20 via the second transparent layer 23. For example, when the light rays enter the optical plate 20 via the first transparent layer 21, a viewing angle of a liquid crystal display device using the backlight module is somewhat larger than that of the liquid crystal display module when the light rays enter the optical plate 20 of the backlight module via the second transparent layer 23.

Referring to FIG. 5, an optical plate 30 according to a second embodiment is shown. The optical 30 is similar in principle to the optical plate 20 of the first embodiment. The optical plate 30 includes a second transparent layer 33, and a plurality of conical frustum depressions 331. The conical frustum depressions 331 are formed on the second transparent layer 33 in a series of rows. The conical frustum depressions 331 in a same row are connected with each other. The conical frustum depressions 331 in each row are staggered relative to the conical frustum depressions 331 in each of the two adjacent rows. Thus a matrix comprised of offset rows of the conical frustum depressions 331 is formed. This configuration means that all the conical frustum depressions 331 in the matrix are arranged relatively compactly together.

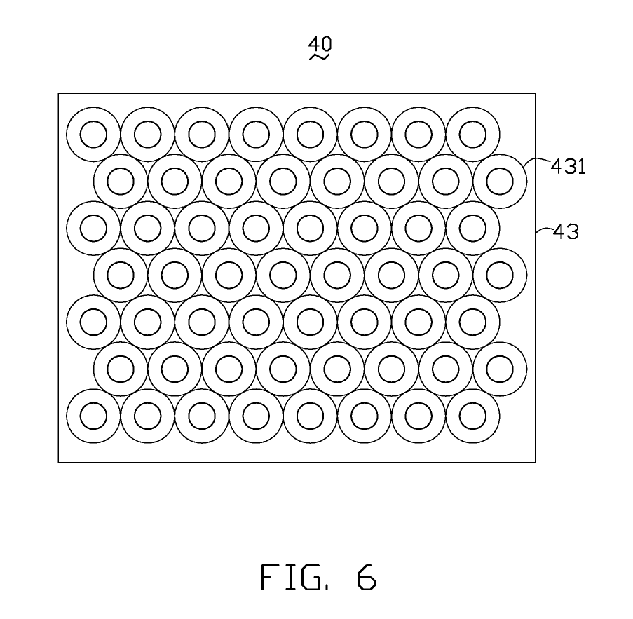

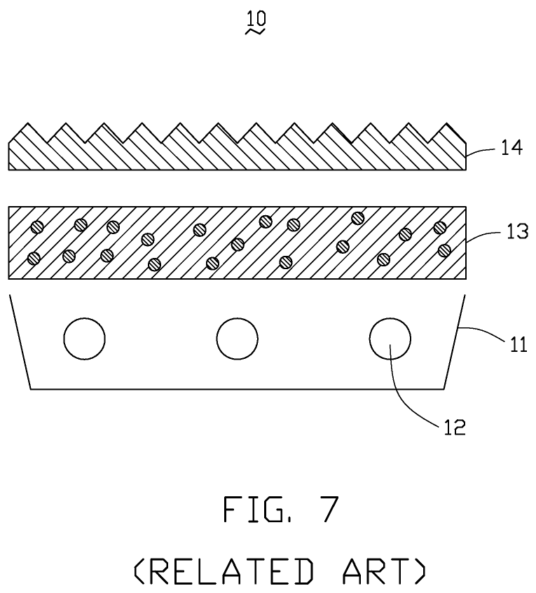

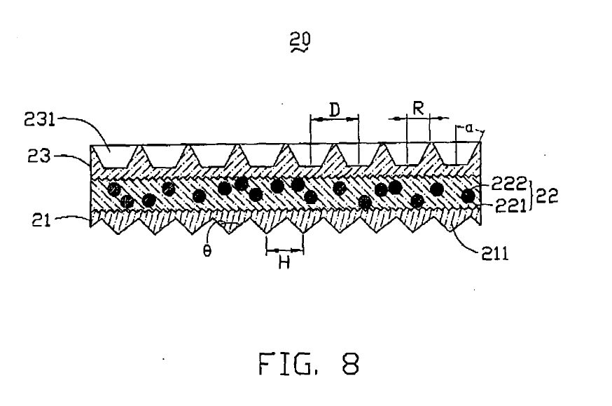

Referring to FIG. 6, an optical plate 40 according to a third embodiment is shown. The optical 40 is similar in principle to the optical plate 30 of the second embodiment. The optical plate 40 includes a second transparent layer 43, and a plurality of conical frustum depressions 431. The conical frustum depressions 431 are formed on the second transparent layer 43 in a series of rows. The conical frustum depressions 431 in a same row are connected with each other. The conical frustum depressions 431 in each row are staggered relative to the conical frustum depressions 431 in each of the two adjacent rows. Further, each conical frustum depression 431 is connected with the two adjacent conical frustum depressions 431 in each of the two adjacent rows. Thus a regular matrix comprised of offset rows of the conical frustum depressions 431 is formed. This configuration means that all the conical frustum depressions 431 in the matrix are arranged compactly together.

It should be understood that the conical frustum depressions of the present optical plate are not limited to being aligned regularly in a matrix. The conical frustum depressions can alternatively be arranged according to other suitable patterns, or can alternatively be arranged randomly.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. An optical plate, comprising;
a first transparent layer;
a second transparent layer; and
a light diffusion layer between the first transparent layer and the second transparent layer, the light diffusion layer including a transparent matrix resin and a plurality of diffusion particles dispersed in the transparent matrix resin, wherein the first transparent layer, the light diffusion layer, and the second transparent layer are integrally molded together, with the first transparent layer in immediate contact with the light diffusion layer and the second transparent layer in immediate contact with the light diffusion layer such that there are no air or gas pockets trapped between the first transparent layer and die light digestion layer nor between the second transparent layer and the light diffusion layer, the first transparent layer comprises a plurality of V-shaped protrusions protruding out from an outer surface thereof farthest from the light diffusion layer, and the second transparent layer defines a plurality of conical frustum depressions at an outer surface thereof farthest from the light diffusion layer.

2. The optical plate as claimed in claim 1, wherein a thickness of each of the light diffusion layer, the first transparent layer, and the second transparent layer is greater than or equal to 0.35 millimeters.

3. The optical plate as claimed in claim 2, wherein a combined thickness of the light diffusion layer, the first transparent layer, and the second transparent layer is in the range from about 1.05 millimeters to about 6 millimeters.

4. The optical plate as claimed in claim 1, wherein the first and second transparent layers are made of materials selected from the group consisting of polyacrylic acid, polycarbonate, polystyrene, polymethyl methacrylate, methylmethacrylate and styrene, and any combination thereof.

5. The optical plate as claimed in claim 1, wherein a pitch between two adjacent V-shaped protrusions is in the range from about 0.025 millimeters to 1 millimeter.

6. The optical plate as claimed in claim 5, wherein a vertex angle of each V-shaped protrusion is in the range from about 60 degrees to about 120 degrees.

7. The optical plate as claimed in claim 1, wherein a pitch between two adjacent conical frustum depressions is in the range from about 0.025 mm to 1.5 mm.

8. The optical plate as claimed in claim 1, wherein a maximal radius value of each conical frustum depression is in the range from about 6.25 microns to about 0.75 millimeters.

9. The optical plate as claimed in claim 1, wherein an angle defined by an inner side surface of each conical frustum depression with respect to a central axis of each depression is in the range from about 30 degrees to about 75 degrees.

10. The optical plate as claimed in claim 1, wherein the conical frustum depressions are aligned regularly on the outer surface of the second transparent layer in a matrix arrangement.

11. The optical plate as claimed in claim 10, wherein the conical frustum depressions in each row of the matrix are spaced apart from the conical frustum depressions in each of the two adjacent rows of the matrix.

12. The optical plate as claimed in claim 10, wherein the conical frustum depressions in each two adjacent rows of the matrix are closely compacted with each other.

13. The optical plate as claimed in claim 1, wherein at least one of the following interfaces is flat: an interface between the light diffusion layer and the first transparent layer, and an interface between the light diffusion layer and the second transparent layer.

14. The optical plate as claimed in claim 1, wherein at least one of the following interfaces is non-planar: an interface between the light diffusion layer and the first transparent layer, and an interface between the light diffusion layer and the second transparent layer.

15. (canceled)

16. The optical plate as claimed in claim 1, wherein the transparent matrix resin of the light diffusion layer is selected from the group consisting of polyacrylic acid, polycarbonate, polystyrene, polymethyl methacrylate, methylmethacrylate and styrene (MS), and any combination thereof.

17. The optical plate as claimed in claim 1, wherein a material of the diffusion particles is selected from the group consisting of titanium dioxide, silicon dioxide, acrylic resin, and any combination thereof.

18. (canceled)
